(19) United States
(12) Patent Application Publication
(10) Pub. No.: US 2009/0088488 A1
(43) Pub. Date: Apr. 2, 2009

(54) Use of linear siloxanes and process for their preparation

(76) Inventors: Arndt Bruckner, Muelheim a.d. Ruhr (DE); Martin Glos, Borken (DE)

Correspondence Address: FROMMER LAWRENCE & HAUG, 745 FIFTH AVENUE- 10TH FL., NEW YORK, NY, 10151, US

(21) Appl. No.: 12/236,778

(22) Filed: Sep. 24, 2008

(30) Foreign Application Priority Data
Sep. 28, 2007 (DE) 102007046736.4

(51) Int. Cl. C08J 9/00

(52) U.S. Cl. 521/110

(57) ABSTRACT

The invention relates to the use of a composition comprising at least one compound of the general formula (I)

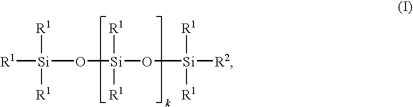

where
R¹ are identical or different, straight-chain or branched, aliphatic or aromatic, optionally halogenated, optionally unsaturated hydrocarbon radicals having 1 to 8 carbon atoms,
k=0 to 10,
R² is a group of the formula A-B-D-Q, where
A is an oxygen atom, a CH₂ group or a CH═CH group,
B is a CH₂ group or a divalent radical selected from linear or branched, saturated, mono- or polyunsaturated alkyloxy, aryloxy, alkylaryloxy or arylalkyloxy groups having 2 to 20 carbon atoms or a group of the formula —CH₂—O—(CH₂)₄—O—,
D is a group of the general formula (II)

(C₂H₄O)ₙ(C₃H₆O)ₒ(C₁₂H₂₄O)ₚ(C₈H₈O)_{q}(C₄H₈O)ᵣ— (II)
where n, o, p, q and r are mutually independent integers from 0 to 50, where the sum of the indices n+o+p+q+r is greater than or equal to 3 and the general formula II represents a statistical oligomer or a block oligomer, and
Q is a radical selected from hydrogen, linear or branched, saturated, mono- or polyunsaturated alkyl, aryl, alkylaryl or arylalkyl groups having 1 to 20 carbon atoms, optionally containing one or more heteroatoms, optionally containing one or more carbonyl groups,
   optionally modified with an ionic organic group, in the production of polyester polyurethane foams, and to a process for producing such compositions.

This application claims benefit under 35 U.S.C. 119(a) of German patent application DE 10 2007 046 736.4, filed on 28 Sep. 2008.

Any foregoing applications, including German patent application DE 10 2007 046 736.4, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

Citation or identification of any document in this application is not an admission that such document is available as prior art to the present invention.

The invention relates to the use of linear polyether siloxanes in the production of polyester polyurethane and to a process for their preparation.

On account of their unique properties such as water repellency, interface activity, temperature stability etc., organomodified siloxanes are used in numerous technique applications. These include the stabilization of polyureathane foams, use as emulsifiers, use in separation coatings and many more besides.

Linear siloxanes which have a diol-functional organic modification are described in the European Patent Application EP 0 356 963 and the European Patent Specification EP 0 277 816 (U.S. Pat. No. 4,839,443). On account of the diol functionality, they can serve as co-reacting comonomers for the preparation of polyurethanes or polyesters, in which case these polymers are thereby improved in their water-repellent and abrasion-reducing properties and also slip properties. A use as stabilizer of polymer foams is not mentioned.

Siloxanes for stabilizing polyurethane foams are usually di- or polymodified. Thus, for example, EP 0 048 984 (U.S. Pat. No. 4,331,555) and the specifications cited therein describe various linear siloxanes having a plurality of lateral groups (cyano groups, polyoxyalkylene groups and phenyl groups) for use in polyester polyurethane foam.

U.S. Pat. No. 5,908,871 refers to a siloxane which is monomodified, based on heptamethyltrisiloxane for use as stabilizer in PU ester foam. Here, during the foaming, the siloxanes are used in amounts of from 1 to 1.5 parts based on 100 parts of the polyol. Here, the organomodified group is in a lateral position, and not in a terminal position, on the siloxane chain.

A disadvantage of the known foam stabilizers is, for example, that they have to be used in relatively high concentrations.

An object of the present invention was to provide alternative compounds for stabilizing polyester polyurethane foams, preferably compounds which, even in low concentrations, enable adequate stabilization of a polyester polyurethane foam.

Surprisingly, it has been found that the object according to the invention can be achieved by linear siloxanes which contain only one organomodified group, this group being bonded to a terminal silicon atom.

The present invention therefore provides the use of a composition comprising at least one compound of the general formula (I)

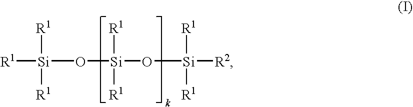

where
R¹ are identical or different, straight-chain or branched, aliphatic or aromatic, optionally halogenated, optionally unsaturated hydrocarbon radicals having 1 to 8 carbon atoms, preferably having one carbon atom,
k=0 to 10, where k, in the case of the presence of only one compound of the formula (I), represents the actual number of units characterized by the index k, and in the case of the presence of a plurality of compounds of the formula (I), the average of the number of units,
R² is a group of the formula A-B-D-Q, where
   A is an oxygen atom, a CH₂ group or a CH═CH group,
   B is a CH₂ group or a divalent radical selected from linear or branched, saturated, mono- or polyunsaturated alkyloxy, aryloxy, alkylaryloxy or arylalkyloxy groups having 2 to 20 carbon atoms or a group of the formula —CH₂—O—(CH₂)₄—O— (where this is inserted into R² as A-CH₂—O— (CH₂)₄—O-D-Q),
   D is a group of the general formula (II)

—(C₂H₄O)ₙ(C₃H₆O)ₒ(C₁₂H₂₄O)ₚ(C₈H₈O)_{q}(C₄H₈O)ᵣ— (II)
where
n, 0, p, q and r are mutually independent integers from 0 to 50, where the sum of the indices n+o+p+q+r is greater than or equal to 3 and the general formula II represents a statistical oligomer or a block oligomer (where in formula II C₁₂H₂₄O is dodecene oxide and C₈H₈O is styrene oxide), and
Q is a radical selected from hydrogen, linear or branched, saturated, mono- or polyunsaturated alkyl, aryl, alkylaryl or arylalkyl groups having 1 to 20 carbon atoms, optionally containing one or more heteroatoms, optionally containing one or more carbonyl groups, optionally modified with an ionic organic group, which can contain, for example, the heteroatoms sulphur, phosphorus and/or nitrogen,
or technical-grade mixtures comprising these compounds or consisting of at least one compound of the formula (I) in the production of polyester polyurethane foams.

The present invention likewise provides a process for the preparation of a composition comprising compounds of the general formula (I) as defined above, characterized in that it has the process steps
a) equilibration of a mixture comprising R¹₃SiO_{1/2}-group- and R¹₂SiO_{2/2}-group-containing siloxanes and HSiR¹₂O_{1/2}-group- and R¹₂SiO_{2/2}-group-containing siloxanes and optionally cyclosiloxanes, where the molar ratio of R¹₃SiO_{1/2}-groups to HSiR¹₂O_{1/2}-groups is from 1:4 to 9:1,
b) reaction of the equilibration mixture obtained in process step a) with a compound A′-B-D-Q where A′=an OH group, a vinyl group or an ethynyl group and B, D and Q are as defined above.

The use of compositions according to the invention which have siloxanes of the formula (I) or consist of them has the advantage that the siloxanes can be used in smaller amounts than in the systems known hitherto in the polyester polyurethane foam without resulting in flawed foams.

Furthermore, the foams obtained in the case of the use according to the invention of the composition are more open-celled than in the case of the use of the siloxanes known hitherto. A lower siloxane fraction can also offer advantages during further use and processing of the foams. For example, better flame laminatability and/or improved water absorption can result from the lower siloxane fraction.

The siloxane and/or compositions used according to the invention and a process for their preparation are described below by way of example without any intention to limit the invention to these exemplary embodiments. Where ranges, general formulae or compound classes are given below, these are intended to include not only these corresponding ranges or groups or compounds that are explicitly mentioned, but also all part ranges and part groups of compounds which can be obtained by removing individual values (ranges) or compounds. Where documents are cited in the course of the present description, the contents are intended, in their entirety, to belong to the disclosure content of the present invention.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

The use according to the invention is characterized in that a composition comprising at least one compound or consisting of at least one compound of the general formula (I)

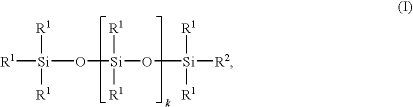

where
R¹ are identical or different, straight-chain or branched, aliphatic or aromatic, optionally halogenated, optionally unsaturated hydrocarbon radicals having 1 to 8 carbon atoms, preferably having one carbon atom (methyl radical),
k=0 to 10, preferably 1 to 7, more preferably from 1 to 4, where k, in the case of the presence of only one compound of the formula (I), represents the actual number of units characterized by the index k, and in the case of the presence of a plurality of compounds of the formula (I), the average of the number of units,
R² is a group of the formula A-B-D-Q, where
   A is an oxygen atom, a CH₂ group or a CH═CH group,
   B is a CH₂ group or a divalent radical selected from linear or branched, saturated, mono- or polyunsaturated alkyloxy, aryloxy, alkylaryloxy or arylalkyloxy groups having 2 to 20 carbon atoms or a group of the formula —CH₂—O—(CH₂)₄—O—,
   D is a group of the general formula (II)

(C₂H₄O)ₙ(C₃H₆O)ₒ(C₁₂H₂₄O)ₚ(C₈H₈O)_{q}(C₄H₈O)ᵣ— (II)
where n, 0, p, q and r are mutually independent integers from 0 to 50, where the sum of the indices n+o+p+q+r is greater than or equal to 3 and the general formula II represents a statistical oligomer or a block oligomer, and
Q is a radical selected from hydrogen, linear or branched, saturated, mono- or polyunsaturated alkyl, aryl, alkylaryl or arylalkyl groups having 1 to 20 carbon atoms, optionally containing one or more heteroatoms, optionally containing one or more carbonyl groups, optionally modified with an ionic organic group, which can contain, for example, the heteroatoms sulphur, phosphorus and/or nitrogen,
   is used in the production of polyester polyurethane foams.

As is evident from the definition of the radical R², the binding of the radical R² can take place via a carbon atom (SiC linkage) or an oxygen atom (SiOC linkage).

Preferably, the composition has compounds of the formula (I), or consists of these, in which all of the radicals R¹ in the general formula (I) are methyl groups. Preferably, the composition has compounds of the formula (I), or consists of these, in which the radical R¹ of the general formula (I) represents methyl groups, p=q=r=0, the sum of the indices n+o is greater than or equal to 3 and Q is selected from the group comprising hydrogen and

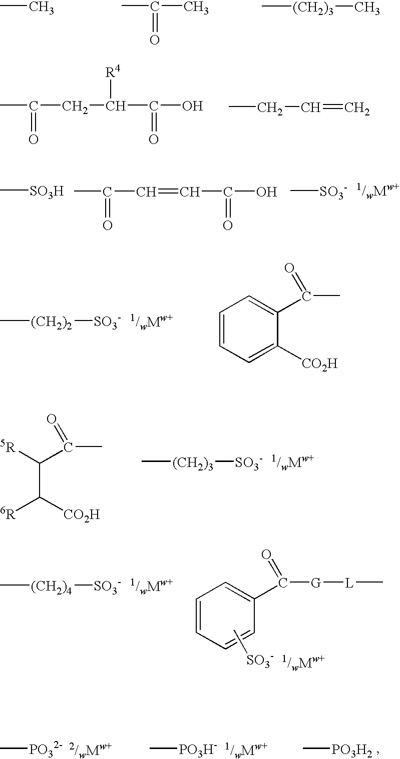

where
M^{w+} is a w-valent cation where w=1, 2, 3 or 4, in particular K⁺, Na⁺, NH₄⁺, (iC₃H₇)NH₃⁺ or (CH₃)₄N⁺, and
R⁴ is hydrogen or an optionally branched aliphatic radical having 1 to 20 carbon atoms,
R⁵ and R⁶ are identical or different, bridged or unbridged, branched or unbranched aliphatic radicals, preferably having 1 to 20 carbon atoms,
G is an oxygen atom, NH or an NR⁷ group, where R⁷ is a monovalent alkyl group, preferably having 1 to 4 carbon atoms,
L is a divalent branched or unbranched alkyl radical optionally containing oxygen and/or nitrogen, preferably a radical having 3 to 6 carbon atoms and 0 to 1 nitrogen atom.

Preferably, the composition has compounds of the formula (I), or consists of these, in which the radical R¹ of the general formula (I) represents exclusively methyl groups, p=q=r=0, the sum of the indices n+o is greater than or equal to 3, and Q is selected from the group comprising hydrogen, acetyl, methyl, ethyl, butyl and allyl radicals.

It is known to the person skilled in the art that the compounds are present in the form of a mixture with a distribution regulated essentially by statistical laws. For example, in the composition, a mixture of compounds of the formula (I) where k=1, 2, 3 and 4 etc. may be present. For the purposes of the invention, it has proven particularly favourable if the compounds of the general formula (I) are used as a mixture. It is then possible to dispense with a complex separation.

In a preferred embodiment of the use according to the invention, use is made of siloxanes of the formula (I) in which the radical A is a CH₂ group. In this embodiment, the binding of the radical R² takes place via a SiC linkage.

In a further preferred embodiment of the use according to the invention, use is made of siloxanes of the formula (I) in which the radical A is an oxygen atom. In this embodiment, the binding of the radical R² takes place via an Si—O—C linkage.

Besides the compounds of the formula (I), the composition used according to the invention can have one or more difunctional compounds of the general formula (III)

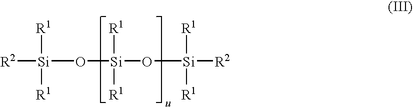

where the radicals R¹ and R² are as defined above and u=0 to 20, preferably 1 to 10, where u, in the case of the presence of only one compound of the formula (III), represents the actual number of the units characterized with the index u, and in the case of the presence of a plurality of compounds of the formula (III), the average of the number of units. The molar ratio of the difunctional compounds of the formula (III) to monofunctional compounds of the formula (I) is preferably <or =⅓, preferably ≦0.2, particularly preferably from ≦0.1 to >0.

Besides the compounds of the formula (I), the composition used according to the invention can have one or more compounds of the general formula (IV)

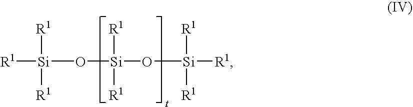

where R¹ is as defined in claim 1 and t=0 to 20, preferably 1 to 10, where t, in the case of the presence of only one compound of the formula (IV), represents the actual number of units characterized with the index t, and in the case of the presence of a plurality of compounds of the formula (IV), represents the average of the number of units.

The molar ratio of the formula (IV) to monofunctional compounds of the formula (I) is preferably <or =15 mass %, more preferably ≦10 mass %, very particularly preferably ≦5 mass %. According to the invention, however, it is also possible to use compositions which have no compounds of the formula (IV).

Polyester polyurethane foams can be produced, for example, by reacting a reaction mixture consisting of
a) a polyesterpolyol which carries on average at least two hydroxy groups per molecule,
b) a polyisocyanate which carries on average at least two isocyanate groups per molecule, where the polyol and the polyisocyanate make up the majority of the reaction mixture and the ratio of these two components relative to one another is suitable for producing a foam,
c) a blowing agent in small amounts which suffices for the foaming of the reaction mixture,
d) a catalytic amount of a catalyst for producing the polyurethane foam, this consists in most cases of one or more amines, and
e) a foam stabilizer, consisting of siloxanes and/or other surfactants, which adequately stabilizes the foaming mixture.

Thus, the siloxanes of the general formula (I) can also be used on their own or in combination with non-Si-containing surfactants as stabilizer. The siloxanes of the general formula (I) can also be diluted in suitable solvents in order to simplify the dosability or else to improve the incorporability into the reaction mixture.

Accordingly, the compositions used according to the invention can comprise
a) a polyesterpolyol which preferably carries on average at least two hydroxy groups per molecule,
b) a polyisocyanate which preferably carries on average at least two isocyanate groups per molecule, where polyesterpolyols and polyisocyanates make up the majority of the composition (reaction mixture) and the ratio of the two components relative to one another should be suitable for producing a foam,
c) a blowing agent which suffices for the foaming of the reaction mixture,
d) a catalytic amount of a catalyst for producing the polyurethane foam, preferably a catalyst having one or more amines, and optionally
e) at least one foam stabilizer, different from compounds of the formula (I), which adequately stabilizes the foaming mixture.

Further additives that may be present in the composition used according to the invention are: flame retardants, cell openers, dyes, UV stabilizers, substances for preventing microbial attack and further additives which are obvious to the person skilled in the art and are not listed here more specifically.

The polyesterpolyols, isocyanates, blowing agents, flame retardants, catalysts, additives and production processes known according to the prior art can be used. For example, the components specified in the EP 0 048 984, which is hereby cited as reference, can be used.

For the use according to the invention, preference is given to using the composition in an amount such that the fraction of the compound of the general formula (I) in the mixture to be foamed is preferably from 0.05 to 1 mass %, preferably from 0.07 to 0.8 mass % and particularly preferably from 0.1 to 0.5 mass %. The fraction of the compound of the formula (III) in the mixture to be foamed is preferably from 0 to 0.2 mass %, preferably from 0 to 0.1 mass % and particularly preferably from 0.01 to 0.06 mass %. The fraction of the compound of the formula (IV) in the mixture to be foamed is preferably from 0 to 0.15 mass %, preferably from 0.001 to 0.1 mass % and particularly preferably from 0.002 to 0.05 mass %.

The siloxanes used according to the invention can be produced in a known manner according to the prior art. Thus, the linear siloxanes can be synthesized, for example, by firstly preparing a siloxane with only one SiH functionality at one end by ring-opening polymerization of cyclosiloxanes, in particular hexamethylcyclotrisiloxane, which is then organomodified in a hydrosilylation reaction. The ring-opening polymerization of cyclosiloxanes is well known to the person skilled in the art and is described, for example, in J. Chojnowski, M. Cypryk, Synthesis of Linear Polysiloxanes, chapter 1 in R. G. Jones et al., Silicon-Containing Polymers, Kluwer, 2000.

These known processes, which make use of the ring-opening polymerization of cyclosiloxanes, are characterized by several disadvantages: as a rule, the cyclosiloxane used has to be the ring-strained hexamethylcyclotrisiloxane, which is produced only in a small amount in siloxane raw material production processes. Moreover, the use of very moisture-sensitive and toxicologically hazardous lithium bases is required.

The siloxanes of the formula (I) used according to the invention or the compositions used according to the invention are therefore preferably prepared by the process according to the invention described below, which does not have the disadvantages of the process of the prior art.

The process according to the invention for preparing a composition comprising compounds of the general formula (I) as defined above, is characterized in that it has the process steps
a) equilibration of a mixture comprising R¹₃SiO_{1/2}-group- and R¹₂SiO_{2/2}-group-containing siloxanes and HSiR¹₂O_{1/2}-group- and R¹₂SiO_{2/2}-group-containing siloxanes and optionally cyclosiloxanes, where the molar ratio of R¹₃SiO_{1/2} groups to HSiR¹₂O_{1/2} groups is from 1:4 to 9:1, preferably from 1:1 to 6:1, particularly preferably from 3:2 to 5:1 and very particularly preferably from 5:2 to 4:1 (or the siloxanes are used in a ratio such that this ratio is present),
b) reaction of the equilibration mixture obtained in process step a) with a compound A′-B-D-Q,
   where A′=a OH group, a vinyl group or an ethynyl group and R¹, B, D and Q are as defined above, preferably R¹=methyl.

The equilibration in process step a) can be carried out in a manner known to the person skilled in the art, or as described in the prior art. Suitable methods for the equilibration of siloxanes are described, for example, in the patent Specification EP 1 439 200 (U.S. Pat. No. 7,196,153), and also in W. Noll, Chemie und Technologie der Silicone (Chemistry and Technology of Silicones), Verlag Chemie, Weinheim, 2nd Edition 1968, pages 187-197. The content of these specifications is hereby incorporated by reference and forms part of the disclosure content of the present application.

It may be advantageous, in process step a), to carry out the equilibration with an excess of HSiMe₂ groups compared with R¹₃Si groups, and in so doing to reduce the fraction of silicone oil (compounds of the formula (IV)) in the equilibration mixture. This leads, statistically, after carrying out process step b), to an increased fraction of difunctional product of the general formula (III). Applications are thus possible in which such a mixture possibly advantageously—can be used in which the presence of the difunctional product does not disrupt the application or in which the presence even exhibits a positive effect for the application. Reducing the fraction of silicone oil in the equilibration mixture can optionally dispense with its removal (optional process step c)) and thus simplify the process considerably.

In a preferred embodiment of the process according to the invention, for the reaction in process step b), a hydrosilylation reaction is carried out. The compound A′-B-D-Q is thus linked to the siloxane via an Si—C bond.

Possible hydrosilylation processes which can be used as process step b) are described, for example, in Bogdan Marciniec, “Comprehensive Handbook on Hydrosilylation”, Pergamon Press 1992; Iwao Ojima, “The hydrosilylation reaction” in “The chemistry of organic silicon compounds” (editors S. Patai and Z. Rappoport), Wiley 1989 and in Iwao Ojima et al., “Recent advances in the hydrosilylation and related reactions” in “The chemistry of organic silicon compounds, Vol. 2”, (editors Z. Rappoport and Y. Apeloig), Wiley 1998, to which reference is expressly made and the contents of which form part of the disclosure content of the present application.

In a further preferred embodiment of the process according to the invention, for reaction in process step b), a dehydrogenative condensation is carried out. This can, for example, be carried out by condensing the SiH-group-containing equilibration mixture obtained in process step a) with hydroxy-functional organic compounds, such as, for example, alcohols, with the liberation of hydrogen gas. Such reactions are described, for example, in the book “Silicone Chemie und Technologie [Silicone Chemistry and Technology]”, Vulkan-verlag Essen, 1989, and in the EP 1 460 098 (U.S. Pat. No. 7,053,166), DE 103 12 636 (U.S. Patent Application Publication 2004-0186260), DE 103 59 764 (U.S. Patent Application Publication 2007-0299231), DE 10 2005 051 939 (U.S. Application Publication 2007-0100153) and EP 1 627 892 (U.S. Application Publication 2006-0041097) and also in JP 48-19941, to which U.S. Pat. No. 5,147,965 refers. The content of these specifications is hereby incorporated by reference and forms part of the disclosure content of the present application. The alcohols used here are preferably OH-terminated polyethers.

The molar ratio of reactive groups (OH groups in the case of the dehydrogenative condensation, hydrosilylatable multiple bonds in the case of the hydrosilylation reaction) to silane hydrogen groups can be chosen arbitrarily in process step b). Preferably, a molar ratio of from 1 to 2, more preferably from 1 to 1.5, is established.

It may be advantageous if, following process step b), in a process step c), compounds of the general formula (IV)

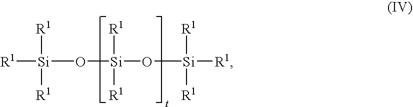

where R¹ is as defined in claim 1 and t=0 to 20, preferably 1 to 10, where t in the case of the presence of only one compound of the formula (IV) represents the actual number of units characterized with the index t, and in the case of the presence of a plurality of compounds of the formula (IV), the average number of units, are completely or partially removed, for example by distillation, from the reaction mixture obtained in process step b). In this way, it is possible to obtain a composition which has a small fraction of unmodified siloxanes (compounds of the formula (IV)) or none of these compounds. Compounds of the formula (IV) may be, for example, hexamethyldisiloxane, octamethyl-trisiloxane, decamethyltetrasiloxane, dodecamethylpenta-siloxane or tetradecamethylhexasiloxane. In particular, in this way, silicone oil formed in the course of process step a) and/or unreacted starting material can be separated off and the content in the composition be reduced.

Distillative, complete or partial removal of the compounds of the formula (IV) can be carried out, for example, at a bottom temperature of from 60 to 150° C., preferably from 100 to 145° C., optionally under reduced pressure, preferably under an operatively realizable vacuum.

However, cases may also be possible where the silicone oil that is present exhibits a desired effect.

The process according to the invention, in particular process steps a) and b), can be carried out in the presence of a solvent, such as, for example, toluene, xylene or water, or preferably without the presence of solvents. The process according to the invention, in particular process steps a) and/or b), can be carried out continuously or discontinuously. In process steps a) and b), the reactants can be mixed together in any order.

The compounds of the general formula (I) can also be produced by processes other than the equilibrium process. These are in particular, but not exclusively, anionic and cationic ring-opening polymerizations of siloxane cycles, as described in J. Chojnowski, M. Cypryk, Synthesis of Linear Polysiloxanes, chapter 1 in R. G. Jones et al., Silicon-Containing Polymers, Klumer, 2000, and for example in U.S. Pat. No. 6,998,437, EP 0499233 (U.S. Pat. No. 5,183,912), JP 01-098631, JP 2005/047852, WO 2006/102050 (U.S. Patent Application Publication 2006-0229423) and WO 2006/122704 (U.S. Patent Application Publication 2008-0167487). In the case of SiH-terminated siloxanes, the organic group can be attached in the course of a hydrosilylation reaction or a dehydrogenative condensation. In the case of SiCl-terminated siloxanes, an OH-terminated organic group can be attached through the HCl-liberating condensation known to the person skilled in the art. The content of these specifications is hereby incorporated by reference and forms part of the disclosure content of the present application.

In the examples listed below, the present invention is described by way of example without any intention to limit the invention, the scope of application of which arises from the entire description and the claims, to the embodiments given in the examples.

### WORKING EXAMPLES

### General

### Alcohols Used:

In the case of the dehydrogenative condensation, the polyether alcohols are freed beforehand from all volatile constituents by distillation in vacuo.

### Reaction Procedure:

All of the reactions were carried out under protective gas. In the case of the dehydrogenative condensation, hydrogen was formed, which was drawn off via a bubble counter.

### Analyses:

The conversion was ascertained by determining the remaining SiH functions by means of gas-volumetric hydrogen determination (conversion data in %).

The OH number is ascertained through the reaction of phthalic anhydride with free hydroxy groups. The free acid was back-titrated with a base solution (OH number given in mg of KOH/g of test substance).

The presence of the SiC or Si—O—C linkage was demonstrated in each case by a ²⁹Si—NMR-spectroscopic investigation (with Bruker AVANCE 400 NMR spectrometer with XWIN-NMR 3.1 evaluation software and tetramethylsilane as internal standard) of the reaction product.

The invention is further described by the following non-limiting examples which further illustrate the invention, and are not intended, nor should they be interpreted to, limit the scope of the invention. The average molecular mass was calculated on the basis of the ²⁹Si—NMR data.

### Syntheses:

### Example 1

### Reaction with OH-Terminated Polyether Containing Purely Ethylene Oxide Units (EO) in a Hydrosilylation Reaction

In a 2 l single-necked flask equipped with a stirrer, 775 g of an α,ω-hydride-terminated polydimethylsiloxane of average chain length 9 Si, 724 g of hexamethyldisiloxane and 1.5 g of trifluoromethanesulphonic acid were mixed and stirred for 3 days at room temperature. Subsequently, 30 g of sodium hydrogencarbonate were added to the equilibration mixture, which is stirred for 2 h at room temperature and filtered. A siloxane equilibrate was obtained.

In a 1 l three-necked flask equipped with a stirrer, a high-performance condenser, a heating mantle, a thermometer and a dropping funnel, 142 g of a purely EO-containing polyether started with allyl alcohol (average molar mass of 200 g/mol) were initially introduced, heated to 60° C. and admixed with Karstedt catalyst (platinum-divinyltetramethyldisiloxane complex from ABCR), so that platinum was present in the mixture in a concentration of 5 ppm based on the total mixture weight. Over the course of 3 h 15 min, 381 g of the siloxane equilibrate prepared above were added dropwise. When the reaction was complete, the reaction mixture was freed from volatile substances at a temperature of 130° C. under a membrane pump vacuum of 6 mbar. This gave a clear, yellow liquid which is described by the following statistical formula:

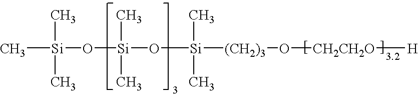

The person skilled in the art is aware that the formula given above is an idealized structural formula. In the product, zero-functional structures (silicone oil) and difunctional structures (corresponding to the general formula III) are additionally present. In particular, the siloxane chain and the polyether chain are length-distributed. The depicted formula shows only the chain length average.

### Example 2

### Reaction with OH-Terminated Polyether Containing Ethylene Oxide Units (EO) and Propylene Oxide Units (PO) in a Hydrosilylation Reaction

In a 2 l four-necked flask equipped with a stirrer, 1039 g of an α,ω-hydride-terminated polydimethylsiloxane of average chain length 9 Si, 964 g of hexamethyldisiloxane and 2 g of trifluoromethanesulphonic acid were mixed and stirred at room temperature for 24 h. Subsequently, 40 g of sodium hydrogencarbonate were added to the equilibration mixture, stirred for 4 h at room temperature and filtered. A siloxane equilibrate was obtained.

In a 1 l three-necked flask equipped with a stirrer, a high-performance condenser, a heating mantle, a thermometer and a dropping funnel, 216 g of an EO/PO-containing polyether started with allyl alcohol (average molar mass of 600 g/mol, about 80% EO, 20% PO) were initially introduced, heated to 90° C. and admixed with Karstedt catalyst (platinum-divinyltetramethyldisiloxane complex from ABCR), so that platinum was present in the mixture in a concentration of 5 ppm based on the total mixture weight. Over the course of 100 min, 207 g of the siloxane equilibrate prepared previously were added dropwise. Subsequently, a further 10 g of the polyether were added and the reaction was completed in 1 h at 90° C. When the reaction was complete, the reaction mixture was freed from volatile substances firstly at a temperature of up to 150° C. under a membrane pump vacuum of 20-30 mbar, then at 150° C. under an oil pump vacuum at 5 mbar and then on a thin-film evaporator at 150° C.

### Example 3

### Reaction with OH-Terminated Polyether Containing Ethylene Oxide Units (EO) and Propylene Oxide Units (PO) in a Hydrosilylation Reaction

In a 2 l single-necked flask equipped with a stirrer, 775 g of an α,ω-hydride-terminated polydimethylsiloxane of average chain length 9 Si, 724 g of hexamethyldisiloxane and 1.5 g of trifluoromethanesulphonic acid were mixed and stirred overnight at room temperature. Subsequently, 30 g of sodium hydrogencarbonate were added to the equilibration mixture, which was stirred for 2 h at room temperature and filtered. A siloxane equilibrate was obtained.

In a 1 l three-necked flask equipped with a stirrer, a high-performance condenser, a heating mantle, a thermometer and a dropping funnel, 235 g of an EO/PO-containing polyether started with allyl alcohol (average molar mass of 900 g/mol, about 70% EO, 30% PO) were initially introduced, heated to 90° C. and admixed with Karstedt catalyst (platinum-divinyltetramethyldisiloxane complex from ABCR), so that platinum was present in the mixture in a concentration of 5 ppm based on the total mixture weight. Over the course of 100 min, 139 g of the siloxane equilibrate prepared previously were added dropwise. When the reaction was complete, the reaction mixture was freed from volatile substances firstly at a temperature of up to 150° C. under a membrane pump vacuum of 20-30 mbar, then at 150° C. under an oil pump vacuum at 5 mbar and subsequently on a thin-film evaporator at 150° C.

### Example 4

### Reaction with OH-Terminated Polyether Containing Ethylene Oxide Units (EO) and Propylene Oxide Units (PO) in a Hydrosilylation Reaction

In a 2 l single-necked flask equipped with a stirrer, 775 g of an α,ω-hydride-terminated polydimethylsiloxane of average chain length 9 Si, 724 g of hexamethyldisiloxane and 1.5 g of trifluoromethanesulphonic acid were mixed and stirred overnight at room temperature. Subsequently, 30 g of sodium hydrogencarbonate were added to the equilibration mixture, which was stirred for 2 h at room temperature and filtered. A siloxane equilibrate was obtained.

In a 1 l three-necked flask equipped with a stirrer, a high-performance condenser, a heating mantle, a thermometer and a dropping funnel, 318 g of an EO/PO-containing polyether started with allyl alcohol (average molar mass of 1500 g/mol, about 60% EO, 40% PO) were initially introduced, heated to 90° C. and admixed with Karstedt catalyst (platinum-divinyltetramethyldisiloxane complex from ABCR), so that platinum was present in the mixture in a concentration of 5 ppm based on the total mixture weight. Over the course of 1 h, 110 g of the siloxane equilibrate prepared previously were added dropwise. When the reaction was complete, the reaction mixture was freed from volatile substances firstly at a temperature of up to 150° C. under a membrane pump vacuum of 20-30 mbar, then at 150° C. under an oil pump vacuum at 5 mbar and then on a thin-film evaporator at 150° C.

### Example 5

### Reaction with Terminally Methyl-Capped Polyether Containing Purely Ethylene Oxide Units (EO) in a Hydrosilylation Reaction

In a 2 l four-necked flask equipped with a stirrer, 1039 g of an α,ω-hydride-terminated polydimethylsiloxane of average chain length 9 Si, 964 g of hexamethyldisiloxane and 2 g of trifluoromethanesulphonic acid were mixed and stirred at room temperature for 24 h. Subsequently, 40 g of sodium hydrogencarbonate were added to the equilibration mixture, which was stirred for 4 h at room temperature and filtered. A siloxane equilibrate was obtained.

In a 1 l three-necked flask equipped with a stirrer, a high-performance condenser, a heating mantle, a thermometer and a dropping funnel, 126 g of a EO-containing polyether started with allyl alcohol and with terminal methyl-capping (average molar mass of 200 g/mol) were initially introduced, heated to 90° C. and admixed with Karstedt catalyst (platinum-divinyltetramethyldisiloxane complex from ABCR), so that platinum was present in the mixture in a concentration of 5 ppm based on the total mixture weight. Over the course of 2 h, 349 g of the siloxane equilibrate prepared previously were added dropwise. Subsequently, a further 19 g of the polyether were added and the reaction was completed for 3 h at 90° C. When the reaction was complete, the reaction mixture was freed from volatile substances firstly at a temperature of up to 150° C. under a membrane pump vacuum of 20-30 mbar, then at 150° C. under an oil pump vacuum at 4 mbar and subsequently on a thin-film evaporator at 150° C.

### Example 6

### Reaction with Terminally Methyl-Capped Polyether Containing Purely Ethylene Oxide Units (EO) in a Hydrosilylation Reaction

In a 2 l four-necked flask equipped with a stirrer, 1039 g of an α,ω-hydride-terminated polydimethylsiloxane of average chain length 9 Si, 964 g of hexamethyldisiloxane and 2 g of trifluoromethanesulphonic acid were mixed and stirred at room temperature for 24 h. Subsequently, 40 g of sodium hydrogencarbonate were added to the equilibration mixture, which was stirred for 4 h at room temperature and filtered. A siloxane equilibrate was obtained.

In a 500 ml three-necked flask equipped with a stirrer, a high-performance condenser, a heating mantle, a thermometer and a dropping funnel, 177 g of a EO-containing polyether started with allyl alcohol and with terminal methyl-capping (average molar mass of 400 g/mol) were initially introduced, heated to 90° C. and admixed with Karstedt catalyst (platinum-divinyltetramethyldisiloxane complex from ABCR), so that platinum was present in the mixture in a concentration of 5 ppm based on the total mixture weight. Over the course of 2 h, 278 g of the siloxane equilibrate prepared previously were added dropwise. Subsequently, a further 19 g of the polyether were added and the reaction was completed for 2 h at 90° C. When the reaction was complete, the reaction mixture was freed from volatile substances firstly at a temperature of up to 150° C. under a membrane pump vacuum of 30 mbar, then at 150° C. under an oil pump vacuum at 4 mbar and subsequently on a thin-film evaporator at 150° C.

### Example 7

### Reaction with Terminally Methyl-Capped Polyether Containing Ethylene Oxide Units (EO) and Propylene Oxide Units (PO) in a Hydrosilylation Reaction

In a 2 l four-necked flask equipped with a stirrer, 1039 g of an α,ω-hydride-terminated polydimethylsiloxane of average chain length 9 Si, 964 g of hexamethyldisiloxane and 2 g of trifluoromethanesulphonic acid were mixed and stirred at room temperature for 24 h. Subsequently, 40 g of sodium hydrogencarbonate were added to the equilibration mixture, which was stirred for 4 h at room temperature and filtered. A siloxane equilibrate was obtained.

In a 500 ml three-necked flask equipped with a stirrer, a high-performance condenser, a heating mantle, a thermometer and a dropping funnel, 238 g of a EO/PO-containing polyether started with allyl alcohol and with terminal methyl-capping (average molar mass of 900 g/mol, 70% EO, 30% PO) were initially introduced, heated to 90° C. and admixed with Karstedt catalyst (platinum-divinyltetramethyldisiloxane complex from ABCR), so that platinum was present in the mixture in a concentration of 5 ppm based on the total mixture weight. Over the course of 1 h, 164 g of the siloxane equilibrate prepared previously were added dropwise. Subsequently, a further 11 g of the polyether were added and the reaction was completed for 2 h at 90° C. When the reaction was complete, the reaction mixture was freed from volatile substances firstly at a temperature of up to 150° C. under a membrane pump vacuum of 20-30 mbar, then at 150° C. under an oil pump vacuum at 5 mbar and subsequently on a thin-film evaporator at 150° C.

### Example 8

### Reaction with Terminally Methyl-Capped Polyether Containing Ethylene Oxide Units (EO) and Propylene Oxide Units (PO) in a Hydrosilylation Reaction

In a 2 l single-necked flask equipped with a stirrer, 775 g of an α,ω-hydride-terminated polydimethylsiloxane of average chain length 9 Si, 724 g of hexamethyldisiloxane and 1.5 g of trifluoromethanesulphonic acid were mixed and stirred overnight at room temperature. Subsequently, 30 g of sodium hydrogencarbonate were added to the equilibration mixture, which was stirred for 2 h at room temperature and filtered. A siloxane equilibrate was obtained.

In a 500 ml three-necked flask equipped with a stirrer, a high-performance condenser, a heating mantle, a thermometer and a dropping funnel, 263 g of an EO/PO-containing polyether started with allyl alcohol and with terminal methyl-capping (average molar mass of 1500 g/mol, 40% EO, 60% PO) were initially introduced, heated to 90° C. and admixed with Karstedt catalyst (platinum-divinyltetramethyldisiloxane complex from ABCR), so that platinum was present in the mixture in a concentration of 5 ppm based on the total mixture weight. Over the course of 1 h 20 min, 95 g of the siloxane equilibrate prepared previously were added dropwise. When the reaction was complete, the reaction mixture was freed from volatile substances firstly at a temperature of up to 150° C. under a membrane pump vacuum of 20-50 mbar, then at 150° C. under an oil pump vacuum at 5 mbar and subsequently on a thin-film evaporator at 150° C.

### Example 9

### Reaction with Sulphopropylated Polyether Containing Purely Ethylene Oxide Units (EO) in a Hydrosilylation Reaction

In a 2 l single-necked flask equipped with a stirrer, 775 g of an α,ω-hydride-terminated polydimethylsiloxane of average chain length 9 Si, 724 g of hexamethyldisiloxane and 1.5 g of trifluoromethanesulphonic acid were mixed and stirred overnight at room temperature. Subsequently, 30 g of sodium hydrogencarbonate were added to the equilibration mixture, which was stirred for 2 h at room temperature and filtered. A siloxane equilibrate was obtained.

The product RALU®MER SPPE from Raschig (polyethylene glycol allyl 3-sulphopropyl diether potassium salt) was dried before the following reactions by azeotroping with toluene. For this, an about 73% strength by weight solution of the anionic polyether in toluene was obtained. The polyether content was determined by the iodine number known to the person skilled in the art. In a 500 ml three-necked flask equipped with a stirrer, a high-performance condenser, a heating mantle, a thermometer and a dropping funnel, 265 g of the solution of the anionic polyether in toluene obtained from the above-described drying were initially introduced, heated to 70° C. and admixed with Karstedt catalyst (platinum-divinyltetramethyldisiloxane complex from ABCR), so that platinum was present in the mixture in a concentration of 5 ppm based on the total mixture weight. Over the course of 1.5 h, 166 g of the siloxane equilibrate prepared previously were added dropwise. When the reaction was complete, the reaction mixture was freed from volatile substances firstly at a temperature of up to 130° C. under a membrane pump vacuum of 20 mbar, then at 130° C. under an oil pump vacuum at 6 mbar.

### Example 10

### Reaction with Alkynes in a Hydrosilylation Reaction

In a 2 l four-necked flask equipped with a stirrer, 1039 g of an α,ω-hydride-terminated polydimethylsiloxane of average chain length 9 Si, 964 g of hexamethyldisiloxane and 2 g of trifluoromethanesulphonic acid were mixed and stirred at room temperature for 24 h. Subsequently, 40 g of sodium hydrogencarbonate were added to the equilibration mixture, which was stirred for 4 h at room temperature and filtered. A siloxane equilibrate was obtained.

In a 1 l three-necked flask equipped with a stirrer, a high-performance condenser, a heating mantle, a thermometer and a dropping funnel, 101 g of Golpanol® BEO (BASF, butynediol etherified with about 2.2 mol of ethylene oxide, average molar mass of 183 g/mol) were heated to 150° C. and admixed with a solution of H₂PtCl₆*6H₂O and RuCl₃*H₂O (from Strem) in isopropanol such that platinum was present in the mixture in a concentration of 10 ppm based on the total mixture weight, and ruthenium was present in the mixture in a concentration of 10 ppm based on the total mixture weight. Over the course of 5 h, 360 g of the siloxane equilibrate prepared previously were added dropwise. When the reaction was complete, the reaction mixture was freed from volatile substances firstly at a temperature of 150° C. under a membrane pump vacuum of 50 mbar and then at 150° C. under an oil pump vacuum at 6 mbar.

### Example 11

### Reaction with OH-Terminated Polyether Containing Purely Propylene Oxide Units (PO) in a Dehydrogenative Condensation

In a 2 l single-necked flask equipped with a stirrer, 561 g of an α,ω-hydride-terminated polydimethylsiloxane of average chain length 9 Si, 514 g of hexamethyldisiloxane, 425 g of decamethylcyclopentasiloxane and 1.5 g of trifluoromethanesulphonic acid were mixed and stirred at room temperature for 24 h. Subsequently, 30 g of sodium hydrogencarbonate were added to the equilibration mixture, which was stirred for 4 h at room temperature and filtered. A siloxane equilibrate was obtained.

In a 2 l three-necked flask equipped with a stirrer, a high-performance condenser, a heating mantle, a thermometer and a dropping funnel, 1057 g of a purely PO-containing polyether started with butanol (average molar mass of 1800 g/mol) were initially introduced, heated to 90° C. and admixed with 770 mg of tris(perfluorotriphenyl)borane. Over the course of 2 h, 475 g of the siloxane equilibrate prepared previously were added dropwise at 100° C. During this, a gas was formed, which was drawn off in a controlled manner. When the reaction was complete, the reaction mixture was freed from volatile substances firstly at a temperature of 146° C. under an oil pump vacuum at 2 mbar and then on a thin-film evaporator at 150° C.

### Comparative Example 1

In accordance with the methods described in DE 43 17 605 (U.S. Pat. No. 5,401,871), a 1,1,1,2,3,3,3-heptamethyltrisiloxane was reacted with an allyl alcohol-started polyether with a PO content of 30% and EO content of 70% and an average molar mass of 900 g/mol with a suitable Pt catalyst to give the corresponding polyether siloxane:

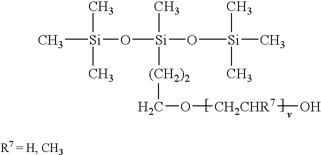

### Examples 12 to 22

### Preparation of Polyester Polyurethane Flexible Foam

Raw materials: Desmophen 2200 from Bayer, tolylene diisocyanate (TDI 80/20) from Bayer, N-methylmorpholine (NMM).

Formulation: 100 parts of polyesterpolyol, 56.5 parts of TDI 80, 5.1 parts of water, 1.4 parts of NMM, 0.13 or 0.26 part of siloxane.

For this, water, amine and siloxane were used to prepare an activated solution with addition of 0.6 part of a polyether with 90% PO and 10% EO and an average molar mass of 2000 g/mol as solubilizer and 0.6 part of a polyoxyethylene sorbitol oleate laurate (trade name: TEGO PEG 30 Tol).

Foaming was carried out on a high-pressure machine from Hennecke, model UBT, with an output of 4 kg/min. The polyol, the isocyanates and the activator solution were metered in separately. The reaction mixture was metered into a container lined with paper and having a base area of 30×30 cm. The increase in height and the drop-back were determined. Drop-back was used to refer to the reduction in the increase in height 1 minute after reaching the maximum increase in height.

After the curing the foams, the cell number and the air permeability were determined. The air permeability is a measure of the fraction of open cells in the foam. For many applications, a foam that is as open-celled as possible is desired. The open-cell content of the foams was determined via the air permeability. The air permeability is given in mm build-up pressure of water column which builds up when a constant stream of air of 480 l/h is passed through the foam. The higher the stated value, the more closed-cell the foam, and vice versa.

Table 1 below summarizes the results of the foamings of siloxanes of the general formula (I) (Examples 12-22) and of a noninventive siloxane of the prior art (Comparative Examples 2 and 3). It gives the siloxane, the amount used (in parts), the foam height (cm), the drop-back (cm), the air permeability (mm) and the cell number (cm⁻¹) of the resulting foams.

TABLE 1
Results of the foaming experiments

| | | | Foam | Drop- | Air | Cell | |
|---|---|---|---|---|---|---|---|
| | Siloxane | Amount | height | back | perm. | number | Re- |
| | from | (parts) | (cm) | (cm) | (mm) | (cm⁻¹) | marks |
| Ex. 12 | Ex. 1 | 0.13 | — | 1.1 | 33 | 13.7 | flawless |
| Ex. 13 | Ex. 2 | 0.13 | 29.2 | 0.5 | 17 | 12.9 | flawless |
| Ex. 14 | Ex. 3 | 0.13 | 28.9 | 0.4 | 15 | 11.6 | relative- |
| | | | | | | | ly |
| | | | | | | | coarse |
| Ex. 15 | Ex. 4 | 0.13 | 29.2 | 1.3 | 16 | 13.9 | flawless |
| Ex. 16 | Ex. 5 | 0.13 | 28.6 | 3.1 | 44 | 14.5 | flawless |
| Ex. 17 | Ex. 6 | 0.13 | 29.5 | 1.5 | 20 | 13.9 | flawless |
| Ex. 18 | Ex. 7 | 0.13 | 29.3 | 1.1 | 17 | 13.3 | flawless |
| Ex. 19 | Ex. 8 | 0.13 | 29.7 | 1.4 | 7 | 13.3 | flawless |
| Ex. 20 | Ex. 9 | 0.13 | 28.8 | 2.5 | 53 | 12.5 | flawless |
| Ex. 21 | Ex. 10 | 0.13 | 29.3 | 1.6 | 52 | 14.7 | flawless |
| Ex. 22 | Ex. 6 | 0.12 | 29.6 | 1.1 | 30 | 14.3 | flawless |
| Comp. | Comp. 1 | 0.39 | 28.7 | 2.6 | 12 | 12 | cracks |
| 2 | | | | | | | |
| Comp. | Comp. 1 | 0.13 | — | — | — | — | collapse |
| 3 | | | | | | | |

As can easily be seen by reference to the results documented in the table, flawless foams are generally obtained when using compositions according to the invention in the production of polyester polyurethane flexible foams.

In addition, known foam stabilizers as exemplified in Comp. 3, resulted in unsuitable foams when used in the same concentration as the siloxanes of the invention. Even tripling the concentration still resulted in unsuitable foams (see Comp. 2).

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. A method of improving the production process/stability for a polyester polyurethane foam which comprises of adding at least one compound of the general formula (I) 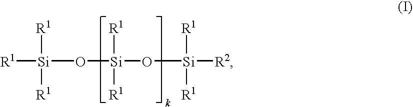
where
R¹ are identical or different, straight-chain or branched, aliphatic or aromatic, optionally halogenated, optionally unsaturated hydrocarbon radicals having 1 to 8 carbon atoms,
k=0 to 10,
R² is a group of the formula A-B-D-Q, where
A is an oxygen atom, a CH₂ group or a CH═CH group,
B is a CH₂ group or a divalent radical selected from linear or branched, saturated, mono- or polyunsaturated alkyloxy, aryloxy, alkylaryloxy or arylalkyloxy groups having 2 to 20 carbon atoms or a group of the formula —CH₂—O— (CH₂)₄—O—,
D is a group of the general formula (II)
(C₂H₄O)ₙ(C₃H₆O)ₒ(C₁₂H₂₄O)ₚ(C₈H₈O)_{q}(C₄H₈O)ᵣ— (II)
where
n, o, p, q and r are mutually independent integers from 0 to 50, where the sum of the indices n+o+p+q+r is greater than or equal to 3 and the general formula II represents a statistical oligomer or a block oligomer, and
Q is a radical selected from hydrogen, linear or branched, saturated, mono- or poly-unsaturated alkyl, aryl, alkylaryl or aryl-alkyl groups having 1 to 20 carbon atoms, optionally containing one or more hetero-atoms, optionally containing one or more carbonyl groups, optionally modified with an ionic organic group,
to a polyester polyurethane foam.

2. The method according to claim 1, characterized in that the radical R¹ of the general formula (I) represents methyl groups, p=q=r=0, the sum of the indices n+o is greater than or equal to 3 and Q is selected from the groups comprising hydrogen and 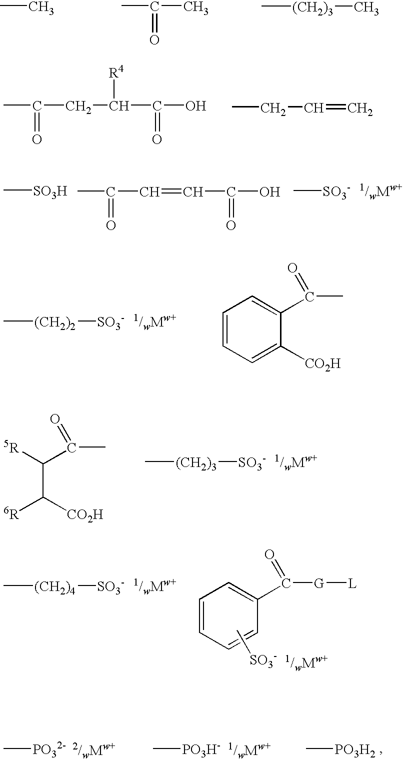
where
M^{w+} is a w-valent cation where w=1, 2, 3 or 4, and
R⁴ is hydrogen or an aliphatic radical having 1 to 20 carbon atoms,
R⁵ and R⁶ are identical or different aliphatic radicals,
G is an oxygen atom, NH or an NR⁷ group, where R⁷ is a monovalent alkyl group, and
L is a divalent, branched or unbranched alkyl radical optionally containing oxygen and/or nitrogen.

3. The method according to claim 1, characterized in that the radical R¹ of the general formula (I) represents exclusively methyl groups, p=q=r=0, the sum of the indices n+o is greater than or equal to 3, and Q is selected from the group comprising hydrogen, acetyl, methyl, ethyl, butyl and allyl radicals.

4. The method according to claim 1, characterized in that the radical A is a CH₂ group.

5. The method according to claim 1, characterized in that the radical A is an oxygen atom.

6. The method according to claim 1, characterized in that the composition has one or more difunctional compounds of the general formula (III) 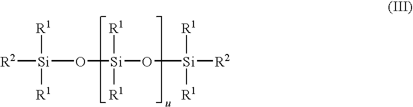
where the radicals are as defined above and u=0 to 20.

7. The method according to claim 6, characterized in that the molar ratio of the difunctional compounds of the formula (III) to monofunctional compounds of the formula (I) is less than or equal to ⅓.

8. The method according to claim 7, characterized in that the molar ratio of the difunctional compounds of the formula (III) to monofunctional compounds of the formula (I) is less than or equal to 0.2.

9. The method according to claim 8, characterized in that the fraction of the compound of the general formula (I) in the mixture to be foamed is from 0.05 to 1 mass %.

10. Process for the preparation of a composition comprising compounds of the general formula (I) as defined in claim 1, characterized in that it has the process steps
a) equilibration of a mixture comprising R¹₃SiO_{1/2}-group- and R¹₂SiO_{2/2}-group-containing siloxanes and HSiR¹₂O_{1/2}-group- and R¹₂SiO_{2/2}-group-containing siloxanes and optionally cyclosiloxanes, where the molar ratio of R¹₃SiO_{1/2} groups to HSiR¹₂O_{1/2} groups is from 1:4 to 9:1,
b) reaction of the equilibration mixture with a compound A′-B-D-Q where A′=an OH group, a vinyl group or an ethynyl group and B, D and Q are as defined in claim 1.

11. Process according to claim 10, characterized in that following process step b), in a process step c), compounds of the general formula (IV) 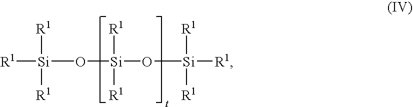
where R¹ is as defined in claim 1 and t=0 to 20 are completely or partially removed by distillation.

12. Process according to claim 10, characterized in that, in process step a), the siloxanes are used in a ratio such that the molar ratio of R¹₃SiO_{1/2} groups to HSiR¹₂O_{1/2} groups is from 1:1 to 6:1.

13. Process according to claim 12, characterized in that, in process step a), the siloxanes are used in a ratio such that the molar ratio of R¹₃SiO_{1/2} groups to HSiR¹₂O_{1/2} groups is from 5:2 to 4:1.

14. Process according to claim 10, characterized in that, for the reaction in process step b), a hydrosilylation reaction is carried out.

15. Process according to claim 10, characterized in that, for the reaction in process step b), a dehydrogenative condensation is carried out.
